(19) United States
(12) Patent Application Publication
(10) Pub. No.: US 2009/0248404 A1
(43) Pub. Date: Oct. 1, 2009

(54) LOST FRAME COMPENSATING METHOD, AUDIO ENCODING APPARATUS AND AUDIO DECODING APPARATUS

(75) Inventors: Hiroyuki Ehara, Kanagawa (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/373,126

(22) PCT Filed: Jul. 11, 2007
(86) PCT No.: PCT/JP2007/063813

§ 371 Date: Jan. 9, 2009

(30) Foreign Application Priority Data
Jul. 12, 2006 (JP) 2006-192069
Mar. 1, 2007 (JP) 2007-051487

(51) Int. Cl. G10L 19/04

(52) U.S. Cl. 704/219; 704/E19.023

(57) ABSTRACT

A frame loss compensating method wherein even when audio codec, which utilizes past sound source information of adaptive codebook or the like, is used as a main layer, the degradation in quality of the decoded audio of a lost frame and following frames is small. In this method, it is assumed that a pitch period ‘T’ and a pitch gain ‘g’ have been obtained as encoded information of a current frame. The sound source information of a preceding frame is expressed by use of a single pulse, and a pulse position ‘b’ and a pulse amplitude ‘a’ are used as encoded information for compensation. Then, an encoded sound source signal is a vector that builds up a pulse having an amplitude ‘a’ at a position that precedes by ‘b’ from the front position of the current frame. This vector is used as the content of the adaptive codebook, so that a vector, which builds up a pulse having an amplitude (g×a) at the position of the current frame (T−b), can be used as an adaptive codebook vector at the current frame. This vector is used to synthesize a decoded signal. The pulse position ‘b’ and pulse amplitude ‘a’ are then decided such that a difference between the synthesized signal and an input signal becomes minimum.

### TECHNICAL FIELD

The present invention relates to a frame erasure concealment method, speech encoding apparatus, and speech decoding apparatus.

### BACKGROUND ART

A speech codec for VoIP (Voice over IP) use is required to be robust against packet loss. It is desirable for a next-generation VoIP codec to achieve error-free quality even at a relatively high frame erasure rate (for example, 6%) (however, transmission of redundant information for concealing errors of erasure is assumed to be used).

In the case of CELP (Code Excited Linear Prediction) speech codecs, frame erasure in a speech onset has a large impact on speech quality in many cases. One reason for this is that signal of an onset frame changes rapidly and the correlation between the signal of the onset frame and the signal of the immediately preceding frame becomes low, and therefore concealment processing using immediately preceding frame information does not work well. Another possible reason is that in a frame of a subsequent voiced section, an excitation signal encoded in the onset section is highly utilized as an adaptive codebook, and therefore the error of the erased onset section persists in subsequent voiced frames, tending to cause marked distortion of a decoded speech signal.

For the above kind of problems, a technology has been developed whereby encoded information for concealment processing is sent together with current frame encoded information (see Patent Document 1, for example) in cases where an immediately preceding or immediately succeeding frame is lost. This technology makes it possible to generate a high-quality decoded signal even if the immediately preceding frame (or immediately succeeding frame) is lost, by transmitting a sub-code in addition to the main-code of the current frame, which is encoded by a main encoder. The sub-code represents the speech signal of the immediately preceding frame (or the speech signal of the immediately succeeding frame) and is generated by encoding the immediately preceding frame speech signal (or immediately succeeding frame speech signal) by means of a sub-encoder. The sub-code is generated only when a speech signal of the frame immediately preceding (or succeeding) the current frame cannot be created artificially using a speech signal of the current frame. Whether the speech signal of the frame immediately preceding (or of the frame immediately succeeding) the current frame can be created artificially using the speech signal of the current frame, is determined by synthesizing a concealed signal for the immediately preceding frame (or immediately succeeding frame) by means of repeating the current frame speech signal or extrapolating characteristic parameters of the encoded information, and comparing this with the speech signal of the immediately preceding frame (or the speech signal of the immediately succeeding frame).

Patent Document 1: Japanese Patent Application Laid-Open No. 2003-249957

### DISCLOSURE OF INVENTION

### Problems to be Solved by the Invention

However, with the above technology, a configuration is used whereby immediately preceding frame (that is, past frame) encoding is performed by a sub-encoder based on current frame encoded information, and it is therefore necessary for the main encoder to use a codec method that enables high-quality decoding of a current frame signal even if immediately preceding frame (that is, past frame) encoded information is lost. Therefore, it is difficult to apply the above technology to a case in which the main encoder employs a predictive type of encoding method that uses past encoded information (or decoded information). In particular, when a CELP speech codec utilizing an adaptive codebook is used as the main encoder, if an immediately preceding frame is lost, decoding of the current frame cannot be performed correctly, and it is difficult to generate a high-quality decoded signal even if the above technology is applied.

It is an object of the present invention to provide a frame erasure concealment method that enables current frame concealment to be performed even if the immediately preceding frame is lost when a speech codec utilizing past excitation information of an adaptive codebook or the like is used as the main encoder, and a speech encoding apparatus and speech decoding apparatus in which that method is applied.

### Means for Solving the Problems

The present invention is a frame erasure concealment method that performs concealment by artificially generating in a speech decoding apparatus a speech signal that should be decoded from a packet lost on a transmission path between a speech encoding apparatus and the speech decoding apparatus, wherein the speech encoding apparatus and the speech decoding apparatus perform the following kinds of operation. The speech encoding apparatus has a step of encoding redundant information, which is for a first frame that is a current frame, that minimizes decoding error of the first frame using encoded information of the first frame. Also, the speech decoding apparatus has a step of, when a packet of a frame immediately preceding the first frame (that is, a second frame) is lost, generating a decoded signal of a packet of the lost second frame using redundant information of the first frame that minimizes decoding error of the first frame.

Also, the present invention is a speech encoding apparatus that generates and transmits a packet containing encoded information and redundant information, and has a current frame redundant information generation section that generates redundant information of a first frame that minimizes decoding error of the first frame that is a current frame using encoded information of the first frame.

Also, the present invention is a speech decoding apparatus that receives a packet containing encoded information and redundant information and generates a decoded speech signal, and has a frame erasure concealment section that takes a current frame as a first frame and takes a frame immediately preceding the current frame as a second frame, and when a packet of the second frame is lost, generates a decoded signal of a packet of the lost second frame using redundant information of the first frame generated in such a way that decoding error of the first frame becomes small.

### ADVANTAGEOUS EFFECT OF THE INVENTION

According to the present invention, when a speech codec that utilizes past excitation information of an adaptive codebook or the like is used as a main encoder, degradation in the quality of a decoded signal of the current frame can be suppressed even if a preceding frame is lost.

### BRIEF DESCRIPTION OF DRAWINGS

FIG. 1 is a drawing for explaining presuppositions of a frame erasure concealment method according to the present invention;

FIG. 2 is a drawing for explaining problems to be solved by the present invention;

FIG. 3 is a drawing for explaining in concrete terms a speech encoding method within a frame erasure concealment method according to an embodiment of the present invention;

FIG. 4 is a drawing for explaining in concrete terms a speech encoding method according to an embodiment of the present invention;

FIG. 5 is a drawing showing pulse position search equations according to an embodiment of the present invention;

FIG. 6 is a drawing showing a error minimization equation according to an embodiment of the present invention;

FIG. 7 is a block diagram showing the main configuration of a speech encoding apparatus according to an embodiment of the present invention;

FIG. 8 is a block diagram showing the main configuration of a speech decoding apparatus according to an embodiment of the present invention;

FIG. 9 is a block diagram showing the main configuration of a preceding frame excitation search section according to an embodiment of the present invention;

FIG. 10 is an operation flowchart of a pulse position encoding section according to an embodiment of the present invention;

FIG. 11 is a block diagram showing the main configuration of a preceding frame excitation decoding section according to an embodiment of the present invention; and

FIG. 12 is an operation flowchart of a pulse position decoding section according to an embodiment of the present invention.

### BEST MODE FOR CARRYING OUT THE INVENTION

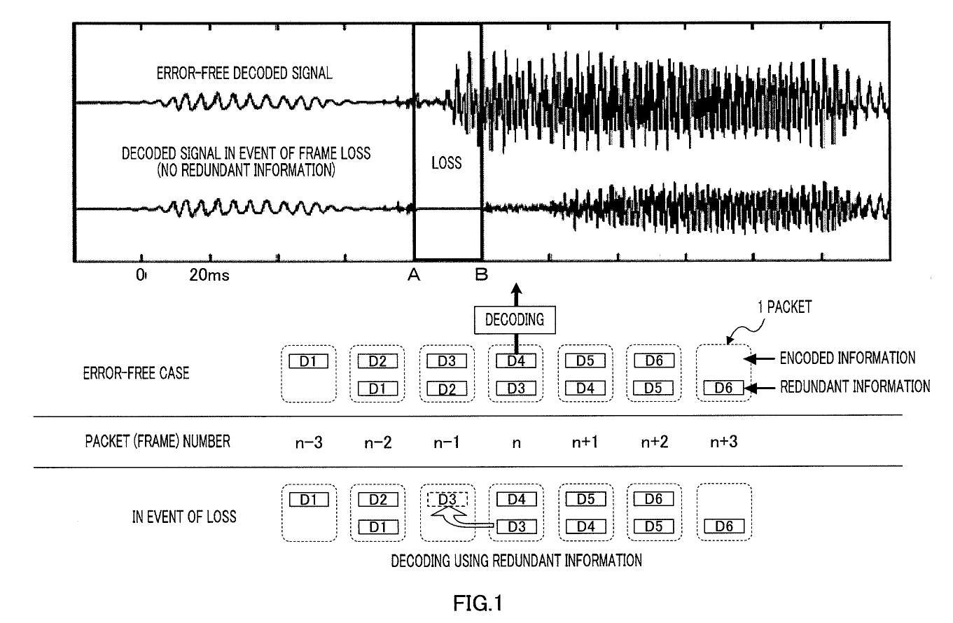

FIG. 1 is a drawing for explaining presuppositions of a frame erasure concealment method according to the present invention. Here, a case in which encoded information of the current frame (frame n in the figure) and encoded information of one frame before (frame n−1 in the figure) is packetized and transmitted in one packet is taken as an example.

By transmitting encoded information of one frame before as redundant information for concealment processing, even if the preceding packet is lost it is possible to decode a speech signal without any influence of the packet loss by decoding information of the preceding frame stored in the current packet. However, since preceding frame encoded information that should have been received in the preceding packet must be extracted after receiving the current packet, a one-frame delay occurs on the decoder side.

The present invention proposes an efficient frame erasure concealment method and redundant information encoding method in a codec that adds preceding frame encoded information to current frame encoded information as redundant information before transmission.

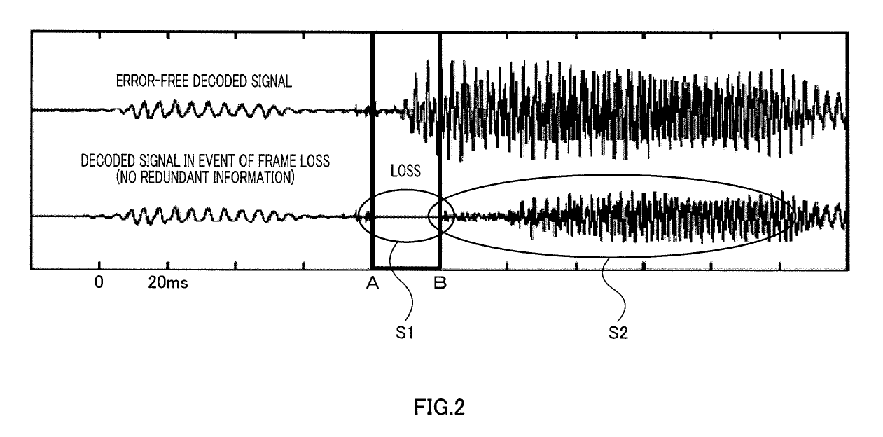

FIG. 2 is a drawing for explaining problems to be solved by the present invention.

In the case of CELP encoding, causes of degradation in quality due to frame loss can be roughly classified into two groups. The first is degradation due to a lost frame itself (S1 in the figure), and the second is degradation in succeeding frames (S2 in the figure).

The former is degradation that occurs due to generation of a signal different from the proper signal by frame erasure concealment processing. Generally, with the kind of method shown in FIG. 1, redundant information is transmitted to enable “the proper signal” not “a signal different from the proper signal”, to be generated. However, if the amount of redundant information is reduced—that is, if the bit rate is lowered—it becomes difficult to perform high-quality encoding of “the proper signal”, and to eliminate degradation due to a lost frame itself.

The other kind of degradation is caused by degradation in a lost frame being propagated to succeeding frames. This is due to the fact that, in CELP encoding, excitation information decoded in the past is used as an adaptive codebook to encode a speech signal of the current frame. For example, if a lost frame is an onset section as shown in FIG. 2, the excitation signal encoded in the onset section is buffered in memory and used in generation of an adaptive codebook vector of a succeeding frame. Here, once the adaptive codebook content (that is, the excitation signal encoded in the onset section) differs from what the proper content should be, a signal of a succeeding frame encoded using this content becomes very different from the correct excitation signal, and degradation in quality is propagated in succeeding frames. This is a particular problem when little redundant information is added for frame erasure concealment. That is to say, as stated earlier, if there is insufficient redundant information, high-quality generation of the signal of a lost frame cannot be performed, and this tends to cause degradation in the quality of succeeding frames.

Thus, in the present invention, whether or not information of an immediately preceding frame encoded as redundant information works effectively when used as a current frame adaptive codebook is used as an evaluation criterion when encoding redundant information.

In other words, in a system in which encoding of an adaptive codebook (that is, a past encoded excitation signal buffer) is performed in the current frame, and this is transmitted as redundant information, the present invention does not perform high-quality encoding of an adaptive codebook itself (that is, does not attempt to encode a past encoded excitation signal as faithfully as possible), but performs adaptive codebook encoding in such a way as to minimize distortion between a decoded signal in the current frame, which is obtained by performing decoding processing using a current frame encoded parameter, and a current frame input signal as small as possible.

An embodiment of the present invention will now be described in detail with reference to the accompanying drawings.

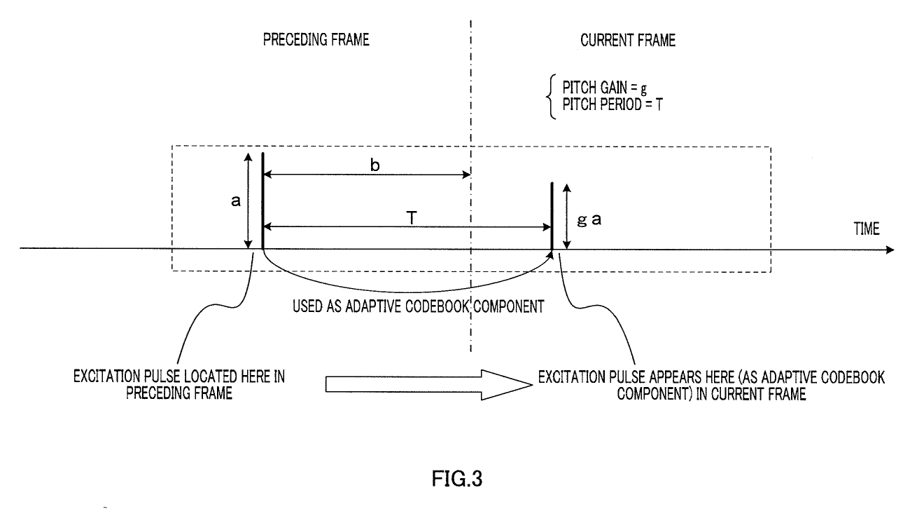

FIG. 3 is a drawing for explaining in concrete terms a speech encoding method according to a frame erasure concealment method according to an embodiment of the present invention.

In this figure, pitch period (or pitch lag or adaptive codebook information) T, and pitch gain (or adaptive codebook gain) g, are assumed to have been obtained as encoded information in the current frame. Then preceding frame excitation information is encoded as one pulse, and this is taken as redundant information for concealment processing. That is to say, a pulse position (b) and pulse amplitude (a, including polarity information) are taken as encoded information. Here, an encoded excitation signal is a vector that consists of one pulse of amplitude a whose position is preceding by b the start position of the current frame. When this is used as adaptive codebook content, a vector that consists of a pulse of an amplitude (g×a) whose position is (T−b) of the current frame becomes an adaptive codebook vector at the current frame. A decoded signal is synthesized using this vector “that consists of a pulse of amplitude ga whose position is (T−b) at the current frame”, and pulse position b and pulse amplitude a are decided so that the difference between the synthesized signal and an input signal becomes minimal. In FIG. 3, with the frame length designated L, the search of a pulse position b is performed in a range from T−b=0 to T−b=L−1.

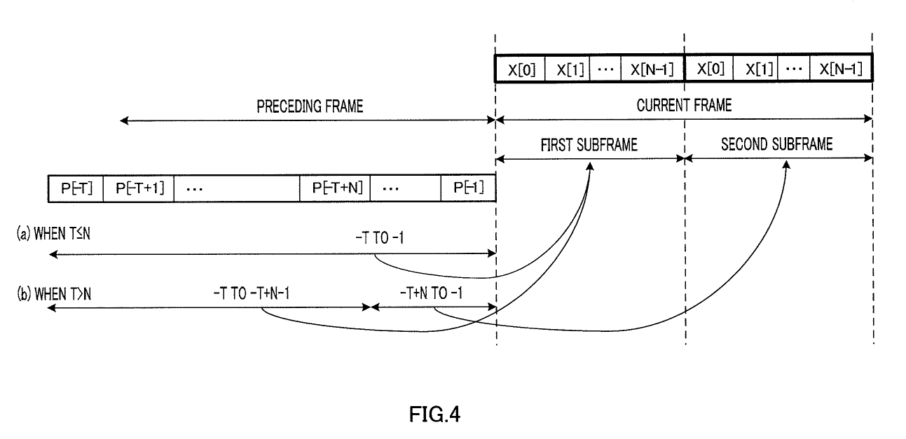

For example, when a frame is composed of two subframes, speech encoding is performed as described below. FIG. 4 is a drawing for explaining this speech encoding method in concrete terms.

The subframe length is designated N, and the position of the first sample of the current frame is taken to be 0. As shown in this figure, a pulse position search is basically performed in a range from −1 to −T (see the case where T≦N in FIG. 4(a). However, when T exceeds N (see FIG. 4(b)), even if a pulse is located in the range −1 to −T+N, when T is of integer precision a pulse does not appear in the current first subframe but appears in the second subframe (however, when T is of fractional precision, if there are many interpolation filter taps, impulses are spread by the Sinc function in equivalence to the number of taps, and therefore a non-zero component may also appear in the first subframe).

Thus, in this case, as shown in FIG. 4, a subframe for which the energy of an excitation signal (an unquantized excitation signal may be used) is maximal is first selected, and then a pulse position is searched for at which the error of a subframe selected from a range depending on the selected subframe—that is, −T to T+N−1 (when the first subframe is selected) or −T+N to −1 (when the second subframe is selected)—is minimized. For example, when the second subframe is selected, if the difference between a pulse position and the start position of the first subframe is designate db, a pulse of amplitude g2*a appears at position [sample number−b+T2]. Here, g2 and T2 represent the pitch gain and pitch period respectively of the second subframe. In this embodiment, a pulse position search is performed by generating a synthesized signal with this pulse as an excitation, and minimizing the error in a perceptually weighted domain.

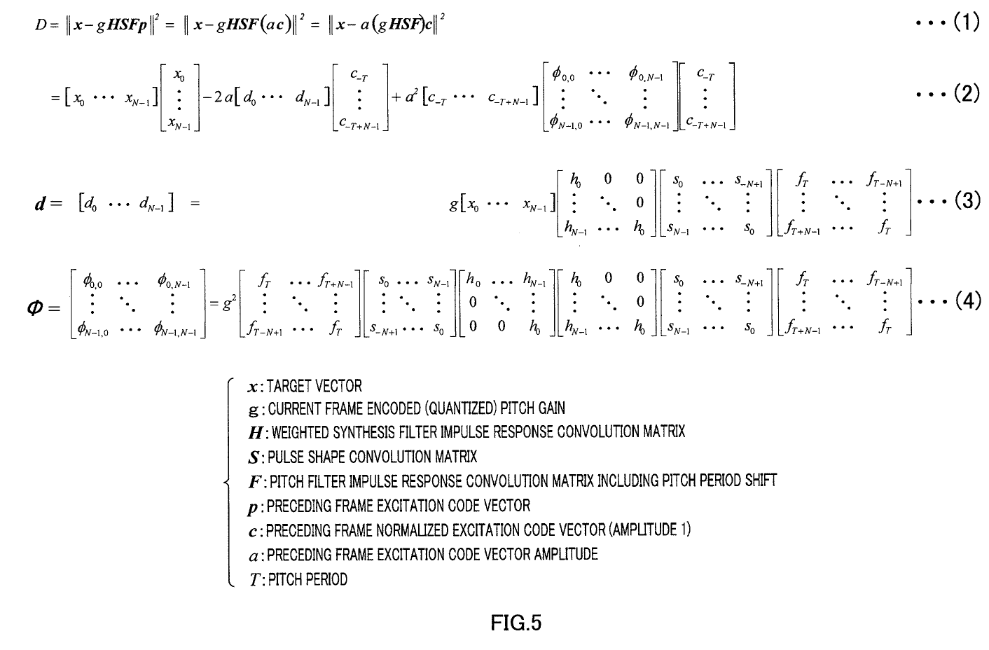

More specifically, it is possible to perform an above-described pulse position search using the equations shown in FIG. 5.

In FIG. 5, x indicates a target vector that is a signal subject to encoding; g indicates quantized adaptive codebook vector gain (pitch gain) encoded in the current frame; H indicates a convolution lower triangular Toeplitz matrix that convolutes a weighted synthesis filter impulse response in the current frame; S indicates a Toeplitz matrix for convoluting the shape of an excitation pulse into an excitation pulse (when an excitation shape is represented by a causal filter—that is, when having a shape only temporally after an excitation pulse—a lower triangular Toeplitz matrix applies (that is, h₋₁ to h_{-N+1}=0), whereas at least a part of h₋₁ to h_{-N+1} is non-zero when also having a shape temporally before an excitation pulse); F indicates a Toeplitz matrix that convolutes a period T pitch filter P(z)=1/(1−gz^{-T}) impulse response from time T (that is, a Toeplitz matrix that convolutes a filter P′(z)=z^{-T}/(1−gz^{-T}) impulse response is a lower triangular Toeplitz matrix (that is, f_{T-1} to f_{T-N+1}=0) when the pitch period is of integer precision, and when the pitch period is of fractional precision the pitch filter is expressed as P(z)=1/(1−gΣ^{I}_{i=I}γᵢz^{-(T-1)}), and therefore f_{T-1} to f_{T-N+}1 and f_{T+1} to f_{T+N+1} are non-zero (where γᵢ is a (2I+1)-order interpolation filter coefficient)); p indicates a preceding frame excitation code vector that expresses a preceding frame excitation vector as an amplitude a pulse sequence; and c indicates a preceding frame excitation code vector represented by an amplitude 1 pulse sequence resulting from normalizing code vector p at amplitude a. Equation (1) represents squared difference D between current frame target vector x (a signal in which a current frame weighted synthesis filter zero input response has been subtracted from a perceptually weighted input signal: the quantization error being zero if the current frame perceptually weighted synthesis filter zero-state response becomes equal to the target vector) and a synthesized signal vector obtained by passing a current frame adaptive codebook vector, which is obtained by using the preceding frame excitation vector as an adaptive codebook, through the current frame perceptually weighted synthesis filter. (that is, in other words, the abovementioned synthesized signal vector is the adaptive codebook component of the current frame synthesized signal). Equation (1) is expressed as shown by Equation (2) if vector d and matrix φ are defined by Equation (3) and Equation (4) respectively.

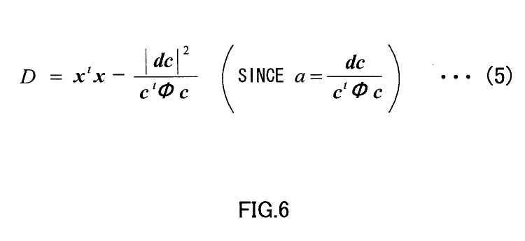

The value of a that minimizes distortion D can be found by making an expression that partially differentiates D with a equal to 0, as a result of which Equation (2) in FIG. 5 becomes as shown by Equation (5) in FIG. 6. Therefore, c should be chosen so that (dc)²/(c^{t}φc) in Equation (5) becomes maximal.

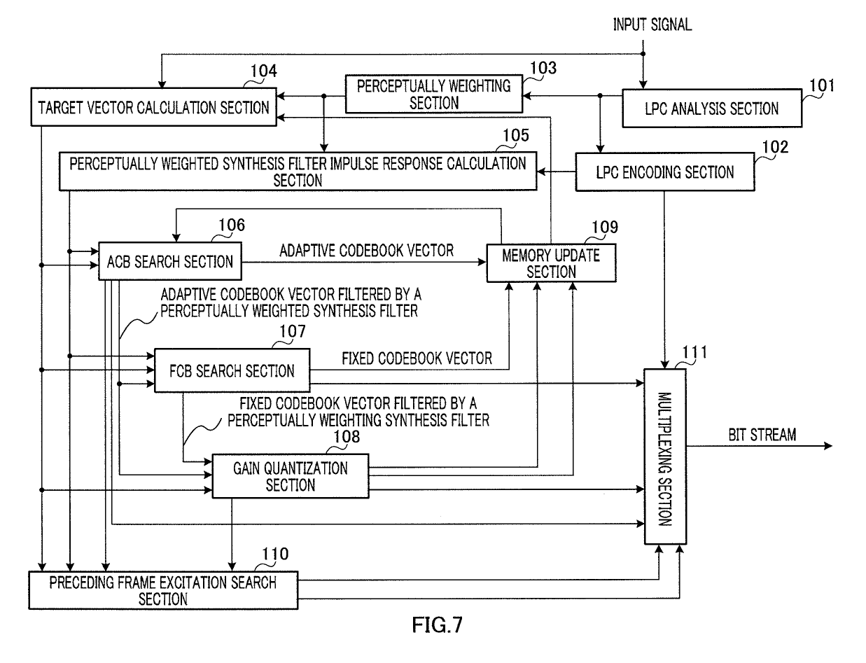

FIG. 7 is a block diagram showing the main configuration of a speech encoding apparatus according to this embodiment.

A speech encoding apparatus according to this embodiment is equipped with linear predictive analysis section (LPC analysis section) 101, linear prediction coefficient encoding section (LPC encoding section) 102, perceptually weighting section 103, target vector calculation section 104, perceptually weighted synthesis filter impulse response calculation section 105, adaptive codebook search section (ACB search section) 106, fixed codebook search section (FCB search section) 107, gain quantization section 108, memory update section 109, preceding frame excitation search section 110, and multiplexing section 111. These sections perform the following operations.

An input signal undergoes necessary preprocessing such as high-pass filtering to cut a direct current component and processing to suppress a background noise signal, and is input to LPC analysis section 101 and target vector calculation section 104.

LPC analysis section 101 performs linear predictive analysis (LPC analysis), and inputs obtained linear prediction coefficients (LPC parameter or simply LPC) to LPC encoding section 102 and perceptually weighting section 103.

LPC encoding section 102 performs encoding of the LPC input from LPC analysis section 101, and inputs the encoded result to multiplexing section 111 and a quantized LPC to perceptually weighted synthesis filter impulse response calculation section 105.

Perceptually weighting section 103 has a perceptually weighting filter, and calculates perceptually weighted filter coefficients using the LPC input from LPC analysis section 101 and inputs these to target vector calculation section 104 and perceptually weighted synthesis filter impulse response calculation section 105. The perceptually weighting filter is generally represented by A(z/γ1)/A(z/γ2) [0<γ2<γ1≦1.0] with respect to LPC synthesis filter 1/A(z).

Target vector calculation section 104 calculates a signal (target vector) in which a perceptually weighted synthesis filter zero input response has been subtracted from a signal resulting from filtering the input signal by the perceptually weighting filter, and inputs this to ACB search section 106, FCB search section 107, gain quantization section 108, and preceding frame excitation search section 110. Here, the perceptually weighting filter comprises a pole-zero filter that uses the LPC input from LPC analysis section 101, and a filter state of the perceptually weighting filter and filter state of the synthesis filter updated by memory update section 109 are input and used.

Perceptually weighted synthesis filter impulse response calculation section 105 calculates an impulse response of a filter cascaded a synthesis filter composed by means of a quantized LPC input from LPC encoding section 102 and a perceptually weighting filter composed by means of a perceptually weighted LPC input from perceptually weighting section 103 (this cascaded filter is called as a perceptually weighted synthesis filter), and inputs this to ACB search section 106, FCB search section 107, and preceding frame excitation search section 110. The perceptually weighted synthesis filter is represented by an expression that multiplies together 1/A(z) and A(z/γ1)/A(z/γ2) [0<γ2<γ1≦1.0].

A target vector from target vector calculation section 104, a perceptually weighted synthesis filter impulse response from perceptually weighted synthesis filter impulse response calculation section 105, and an updated latest adaptive codebook (ACB) from memory update section 109, are input to ACB search section 106. ACB search section 106 decides an ACB vector extracting position at which the error between the vector obtained by convoluting the ACB vector with the perceptually weighted synthesis filter impulse response and the target vector is minimal, and this extracting position is represented by pitch lag T. This pitch lag T is input to preceding frame excitation search section 110. If a pitch periodicity filter is applied to the FCB vector, pitch lag T is input to FCB search section 107. Also, pitch lag code representing encoded pitch lag T is input to multiplexing section 111. In addition, an ACB vector extracted from the extracting position specified by pitch lag T is input to memory update section 109. Furthermore, a vector obtained by convoluting the perceptually weighted synthesis filter impulse response with an ACB vector (result of filtering an adaptive codebook vector by the perceptually weighted synthesis filter) is input to FCB search section 107 and gain quantization section 108.

A target vector from target vector calculation section 104, a perceptually weighted synthesis filter impulse response from perceptually weighted synthesis filter impulse response calculation section 105, and an adaptive codebook vector filtered by a perceptually weighted synthesis filter from ACB search section 106, are input to FCB search section 107. If a pitch synchronization filter is applied to the FCB vector, a pitch filter is configured using pitch lag T input from ACB search section 106, and the impulse response of this pitch filter is convoluted into the perceptually weighted synthesis filter impulse response, or the FCB vector is filtered by the pitch filter. FCB search section 107 decides an FCB vector so that the error between a vector, which is obtained by adding two vectors, one is calculated by multiplying the FCB vector convoluted with the perceptually weighted synthesis filter impulse response (fixed codebook vector filtered by the perceptually weighted synthesis filter) by an appropriate gain, and the other is calculated by multiplying the adaptive codebook vector filtered by the perceptually weighted synthesis filter by an appropriate gain, and the target vector becomes minimal. An index indicating this FCB vector is encoded and becomes FCB vector code, and the FCB vector code is input to multiplexing section 111. If a pitch synchronization filter is applied to the FCB vector, the pitch filter impulse response is convoluted into the FCB vector, or the FCB vector is filtered by the pitch filter. Also, the fixed codebook vector filtered by the perceptually weighted synthesis filter is input to gain quantization section 108.

A target vector from target vector calculation section 104, an adaptive codebook vector filtered by a perceptually weighted synthesis filter from ACB search section 106, and a fixed codebook vector filtered by a perceptually weighted synthesis filter from FCB search section 107, are input to gain quantization section 108. Gain quantization section 108 multiplies the adaptive codebook vector filtered by the perceptually weighted synthesis filter by quantized ACB gain, multiplies the fixed codebook vector filtered by the perceptually weighted synthesis filter by the quantized FCB gain, and then adds the two together. Then a set of quantized gains is decided so that the error between the post-addition vector and target vector becomes minimal, and code (gain code) corresponding to the set of quantized gains is input to multiplexing section 111. Also, gain quantization section 108 inputs quantized ACB gain and quantized FCB gain to memory update section 109. Furthermore, quantized ACB gain is input to preceding frame excitation search section 110.

An ACB vector from ACB search section 106, an FCB vector from FCB search section 107, and quantized ACB gain and quantized FCB gain from gain quantization section 108, are input to memory update section 109. Memory update section 109 has an LPC synthesis filter (also referred to simply as a synthesis filter), and generates a quantized excitation vector, updates the adaptive codebook, and inputs this to ACB search section 106. Memory update section 109 also drives the LPC synthesis filter with the generated excitation vector, updates the filter state of the LPC synthesis filter, and inputs the updated filter state to target vector calculation section 104. In addition, memory update section 109 drives the perceptually weighting filter with the generated excitation vector, updates the filter state of the perceptually weighting filter, and inputs the updated filter state to target vector calculation section 104. Any filter state updating method may be used other than that described here, as long as it is a mathematically equivalent method.

Target value x from target vector calculation section 104, perceptually weighted synthesis filter impulse response h from perceptually weighted synthesis filter impulse response calculation section 105, pitch lag T from ACB search section 106, and quantized ACB gain from gain quantization section 108, are input to preceding frame excitation search section 110. Preceding frame excitation search section 110 calculates d and φ shown in FIG. 5, decides an excitation pulse position and pulse amplitude that maximize (dc)²/(c^{t}φc) shown in FIG. 6, quantizes and encodes this pulse position and pulse amplitude, and inputs pulse position code and pulse amplitude code to multiplexing section 111. The excitation pulse search range is basically from −T to −1 with setting the start position of the current frame to 0, but the excitation pulse search range may also be decided using the kind of method shown in FIG. 4.

LPC code from LPC encoding section 102, pitch lag code from ACB search section 106, FCB vector code from FCB search section 107, gain code from gain quantization section 108, and pulse position code and pulse amplitude code from preceding frame excitation search section 110, are input to multiplexing section 111. Multiplexing section 111 outputs the result of multiplexing these as a bit stream.

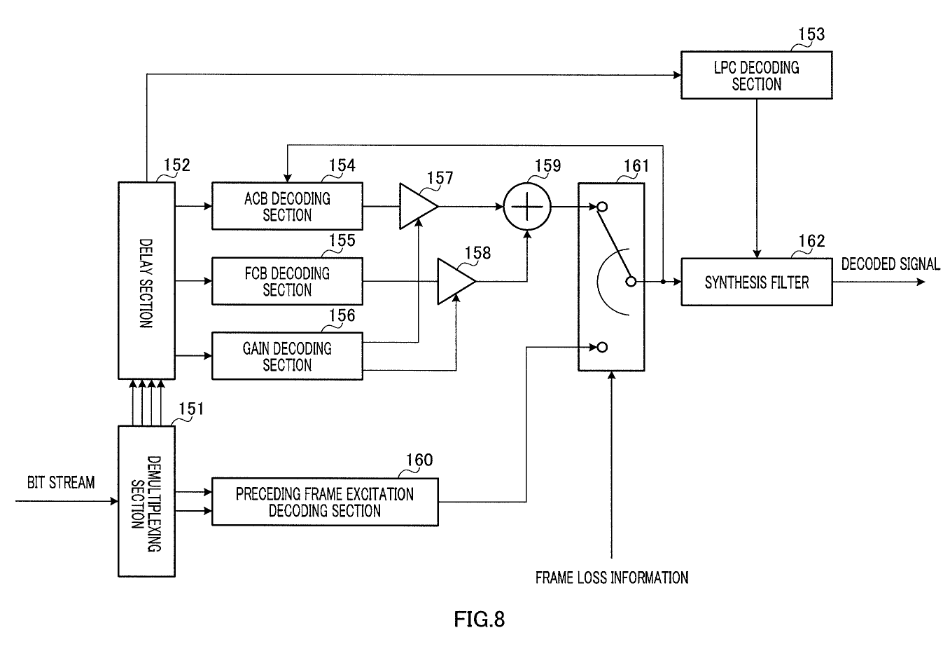

FIG. 8 is a block diagram showing the main configuration of a speech decoding apparatus according to this embodiment that receives and decodes a bit stream output from the speech encoding apparatus shown in FIG. 7.

A bit stream output from the speech encoding apparatus shown in FIG. 7 is input to demultiplexing section 151.

Demultiplexing section 151 separates various codes from the bit stream, and inputs the LPC code, pitch lag code, FCB vector code, and gain code, to delay section 152. The preceding frame excitation pulse position code and pulse amplitude code are input to preceding frame excitation decoding section 160.

Delay section 152 delays the various input codes by a one-frame period, and inputs the delayed LPC code to LPC decoding section 153, the delayed pitch lag code to ACB decoding section 154, the delayed FCB vector code to FCB decoding section 155, and the delayed quantized gain code to gain decoding section 156.

LPC decoding section 153 decodes quantized LPC using the input LPC code, and outputs the decoded LPC code to synthesis filter 162.

ACB decoding section 154 decodes the ACB vector using the pitch lag code, and outputs the decoded ACB vector to amplifier 157.

FCB decoding section 155 decodes the FCB vector using the FCB vector code, and outputs the decoded FCB vector to amplifier 158.

Gain decoding section 156 decodes the ACB gain and FCB gain using the gain code, and inputs the decoded ACB gain and FCB gain to amplifiers 157 and 158 respectively.

Adaptive codebook vector amplifier 157 multiplies the ACB vector input from ACB decoding section 154 by the ACB gain input from gain decoding section 156, and outputs the result to adder 159.

Fixed codebook vector amplifier 158 multiplies the FCB vector input from FCB decoding section 155 by the FCB gain input from gain decoding section 156, and outputs the result to adder 159.

Adder 159 adds together the vector input from adaptive codebook vector amplifier 157 and the vector input from fixed codebook vector amplifier 158, and inputs the addition result to synthesis filter 162 via switch 161.

Preceding frame excitation decoding section 160 decodes the excitation signal using the pulse position code and pulse amplitude code input from demultiplexing section 151 and generates an excitation vector, and inputs this to synthesis filter 162 via switch 161.

Switch 161 has frame loss information indicating whether or not frame loss has occurred as input, and connects the input side to the adder 159 side if the frame being decoded is not a lost frame, or connects the input side to the preceding frame excitation decoding section 160 side if the frame being decoded is a lost frame.

Synthesis filter 162 configures an LPC synthesis filter using decoded LPC input from LPC decoding section 153, and drives this LPC synthesis filter with the signal input via switch 161 and generates a synthesized signal. This synthesized signal is a decoded signal, but is generally output as a final decoded signal after passing through postprocessing such as a post-filter.

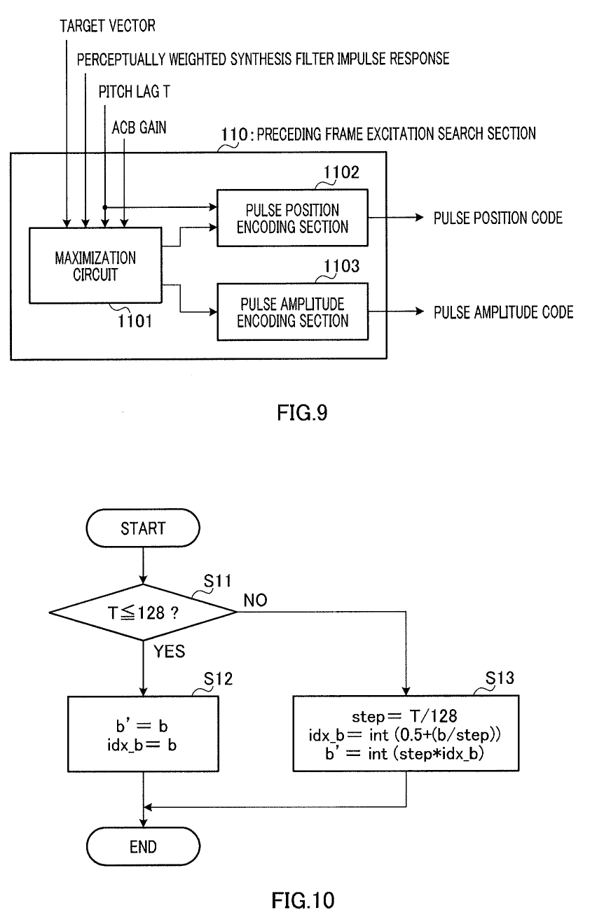

Next, preceding frame excitation search section 110 will be described in detail. FIG. 9 shows the internal configuration of preceding frame excitation search section 110. Preceding frame excitation search section 110 is equipped with maximization circuit 1101, pulse position encoding section 1102, and pulse amplitude encoding section 1103.

Maximization circuit 1101 has a target vector from target vector calculation section 104, a perceptually weighted synthesis filter impulse response from perceptually weighted synthesis filter impulse response calculation section 105, pitch lag T from ACB search section 106, and ACB gain from gain quantization section 108, as input, inputs a pulse position that makes Equation (5) maximal to pulse position encoding section 1102, and inputs the pulse amplitude at that pulse position to pulse amplitude encoding section 1103.

Using pitch lag T input from ACB search section 106, pulse position encoding section 1102 generates pulse position code by quantizing and encoding a pulse position input from maximization circuit 1101 by means of a method described later herein, and inputs this to multiplexing section 111.

Pulse amplitude encoding section 1103 generates pulse amplitude code by quantizing and encoding a pulse amplitude input from maximization circuit 1101, and inputs this to multiplexing section 111. Pulse amplitude quantization may be scalar quantization, or may be vector quantization performed in combination with other parameters.

An example of the quantization and encoding methods used by pulse position encoding section 1102 will now be described.

As shown in FIG. 4, pulse position b is normally less than or equal to T. The maximum value of T is, for example, 143 according to ITU-T Recommendation G.729. Thus, 8 bits are necessary in order to quantize this pulse position b without error. However, since quantization up to 255 is possible with 8 bits, using 8 bits to quantize pulse position b having a maximum value of 143 is wasteful. Here, therefore, when the possible range of pulse position b is 1 to 143, pulse position b is quantized using 7 bits. Pitch lag T of the first subframe of the current frame is used for pulse position b quantization.

The operational flow of pulse position encoding section 1102 will now be described using FIG. 10.

First, in step S11, it is determined whether or not T is less than or equal to 128. The processing flow proceeds to step S12 if T is less than or equal to 128 (step S11: YES), or to step S13 if T is greater than 128 (step S11: NO).

If T is less than or equal to 128, pulse position b can be quantized without error using 7 bits, and therefore in step S12 pulse position b is used as it is for quantization value b′ and quantization index idx_b. Then idx_b−1 is streamed and transmitted as 7 bits.

On the other hand, if T is greater than 128, in order to quantize pulse position b using 7 bits, in step S13 the quantization step (step) is calculated as T/128 and the quantization step is made greater than 1. Also, an integer value obtained by rounding b/step to the nearest integer is taken as pulse position b quantization index idx_b. Thus, pulse position b quantization value b′ is calculated as int(step*int(0.5+(b/step)). Then idx_b−1 is streamed and transmitted as 7 bits.

Next, preceding frame excitation decoding section 160 will be described in detail. FIG. 11 shows the internal configuration of preceding frame excitation decoding section 160. Preceding frame excitation decoding section 160 is equipped with pulse position decoding section 1601, pulse amplitude decoding section 1602, and excitation vector generation section 1603.

Pulse position decoding section 1601 has pulse position code as input from demultiplexing section 151, decodes the quantized pulse position, and inputs the result to excitation vector generation section 1603.

Pulse amplitude decoding section 1602 has pulse amplitude code as input from demultiplexing section 151, decodes the quantized pulse amplitude, and inputs the result to excitation vector generation section 1603.

Excitation vector generation section 1603 locates a pulse having the pulse amplitude input from pulse amplitude decoding section 1602 at the pulse position input from pulse position decoding section 1601 and generates an excitation vector, and inputs that excitation vector to synthesis filter 162 via switch 161.

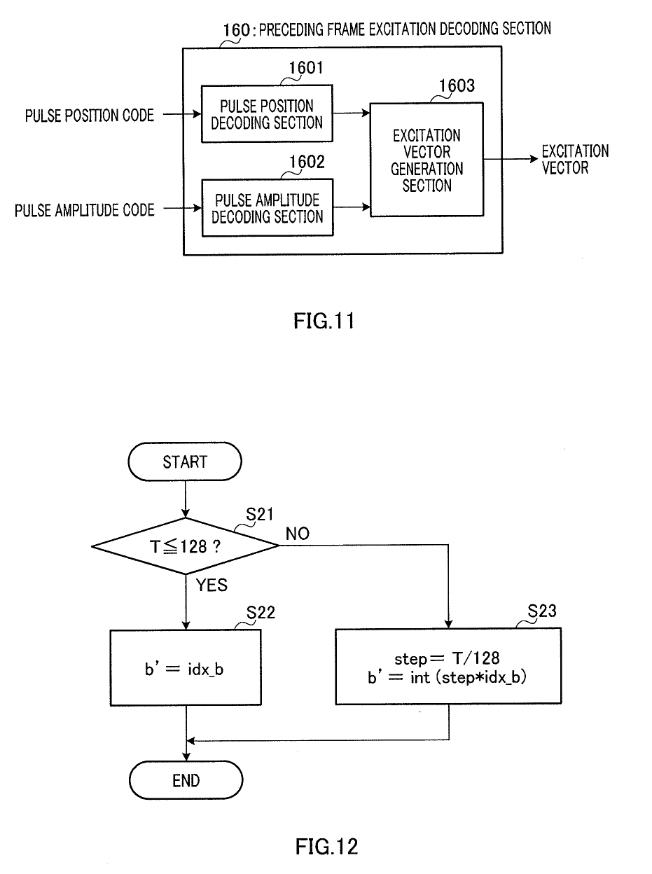

The operational flow of pulse position decoding section 1601 will now be described using FIG. 12.

First, in step S21, it is determined whether or not T is less than or equal to 128. The processing flow proceeds to step S22 if T is less than or equal to 128 (step S21: YES), or to step S23 if T is greater than 128 (step S21: NO).

In step S22, since T is less than or equal to 128, quantization index idx_b is used as it is for quantization value b′.

On the other hand, in step S23, since T is greater than 128, the quantization step (step) is calculated as T/128 and quantization value b, is calculated as int(step* idx_b).

Thus, in this embodiment, if possible pulse position values exceed 128 samples, a pulse position is quantized using one fewer bits (7 bits) than the necessary number of bits (8 bits) according to the possible pulse position values. Even if quantization is performed with a range exceeding 7 bits among pulse position values accommodated in 7 bits, as long as that range is very small, pulse position quantization error can be kept to within one sample. Thus, according to this embodiment, when a pulse position is transmitted as redundant information for frame erasure concealment use, the effect of quantization error can be kept to a minimum.

In this embodiment, a method has been described whereby, when encoding is performed for the current frame, current frame redundant information is generated in such a way that error between a synthesized decoded signal and an input signal becomes minimal, but the present invention is not limited to this, and it goes without saying that as long as current frame redundant information is generated so that error between a synthesized decoded signal and an input signal is made somewhat smaller, it is possible to moderate greatly degradation in the quality of a current frame decoded signal even if the preceding frame is lost.

The above pulse position quantization method is one in which a pulse position is quantized using pitch lag (a pitch period), and is not limited by the pulse position search method or the pitch period analysis, quantization and encoding methods.

In the above embodiment, a case has been described by way of example in which the number of quantization bits is 7, and a pulse position value is a maximum of 143 samples, but the present invention is not limited to these numeric values.

However, in order to keep pulse position quantization error within one sample, it is necessary for the following relationship to hold between maximum possible pulse position value PPₘₐₓ and number of quantization bits PP_{bit}.

2⁻PP_{bit}<PPₘₐₓ<2⁻(PP_{bit}+1)

Also, when quantization error up to 2 samples is permitted, it is necessary for the following relationship to hold.

2⁻PP_{bit}<Pₘₐₓ<2⁻(2⁻PP_{bit}+2)

Thus, this embodiment can be shown as the following kinds of invention with regard to a frame erasure concealment method that performs main-layer frame erasure concealment using sublayer encoded information (sub encoded information) as redundant information for concealment use, and a concealment processing information encoding/decoding method.

Namely, a first invention is a frame erasure concealment method that performs concealment by artificially generating in a speech decoding apparatus a speech signal that should be decoded from a packet lost on a transmission path between a speech encoding apparatus and the speech decoding apparatus, wherein the speech encoding apparatus and the speech decoding apparatus perform the following kinds of operation. The speech encoding apparatus has a step of encoding redundant information of a first frame that is a current frame that makes decoding error of the first frame small using encoded information of the first frame. Also, the speech decoding apparatus has a step of, when a packet of a frame immediately preceding the first frame (that is, a second frame) is lost, generating a decoded signal of a packet of the lost second frame using redundant information of the first frame that makes decoding error of the first frame small.

A second invention is a frame erasure concealment method wherein, in the first invention, decoding error of the first frame is error between a decoded signal of the first frame generated based on decoded information and redundant information of the first frame and an input speech signal of the first frame.

A third invention is a frame erasure concealment method wherein, in the first invention, redundant information of the first frame is information that encodes an excitation signal of the second frame that makes decoding error of the first frame small in the speech encoding apparatus.

A fourth invention is a frame erasure concealment method wherein, in the first invention, the encoding step places a first pulse on the time axis using encoded information and redundant information of the first frame of the input speech signal, places a second pulse indicating encoded information of the first frame at a time later by a pitch period than the first pulse on the time axis, finds the first pulse that makes error between an input speech signal of the first frame and a decoded signal of the first frame decoded using the second pulse small by searching within the second frame, and takes the position and amplitude of the found first pulse as redundant information of the first frame.

A fifth invention is a speech encoding apparatus that generates and transmits a packet containing encoded information and redundant information, and has a current frame redundant information generation section that generates redundant information of a first frame that makes decoding error of the first frame that is a current frame small using encoded information of the first frame.

A sixth invention is a speech encoding apparatus wherein, in the fifth invention, decoding error of the first frame is error between a decoded signal of the first frame generated based on decoded information and redundant information of the first frame and an input speech signal of the first frame.

A seventh invention is a speech encoding apparatus wherein, in the fifth invention, redundant information of the first frame is information that encodes an excitation signal of a second frame that is a frame immediately preceding the current frame that makes decoding error of the first frame small.

An eighth invention is a speech encoding apparatus wherein, in the fifth invention, the current frame redundant information generation section has a first pulse generation section that places a first pulse on the time axis using encoded information and redundant information of the first frame of the input speech signal, a second pulse generation section that places a second pulse indicating encoded information of the first frame at a time later by a pitch period than the first pulse on the time axis, an error minimizing section that finds the first pulse such that error between an input speech signal of the first frame and a decoded signal of the first frame decoded using the second pulse becomes minimal by searching within a second frame that is a frame preceding the current frame, and a redundant information encoding section that encodes the position and amplitude of the found first pulse as redundant information of the first frame. For example, a first pulse is p (=ac) in Equation (1), a second pulse is Fp (=Fac) in Equation (1), and error minimization decides c that makes |dc|²/(c^{t}φc) in Equation (5) maximal. In order to find c that makes the second term in Equation (5) maximal, preceding frame excitation search section 110 calculates d and φ based on Equation (3) and Equation (4), and performs a search for c (that is, a first pulse) that makes the second term in Equation (5) maximal. That is to say, it can be said that first pulse generation, second pulse generation, and error minimization are performed simultaneously by the preceding frame excitation search section. Viewed from the decoder side, the first pulse generation section is a preceding frame excitation decoding section, the second pulse generation section is ACB decoding section 154, and the equivalent of the processing of these is executed in preceding frame excitation search section 110 by means of Equation (1) (or (2)).

A ninth invention is a speech encoding apparatus wherein, in the eighth invention, the redundant information encoding section quantizes a position of the first pulse using one fewer bits than the necessary number of bits according to a possible value of a position of the first pulse, and encodes a post-quantization position.

A tenth invention is a speech decoding apparatus that receives a packet containing encoded information and redundant information and generates a decoded speech signal, and has a frame erasure concealment section that takes a current frame as a first frame and takes a frame immediately preceding the current frame as a second frame, and when a packet of the second frame is lost, generates decoded information of a packet of the lost second frame using redundant information of the first frame generated in such a way that decoding error of the first frame becomes small.

An eleventh invention is a speech decoding apparatus wherein, in the tenth invention, redundant information of the first frame is information generated so that, when a speech signal is encoded, error between a decoded signal of the first frame generated based on encoded information and redundant information of the first frame and a speech signal of the first frame becomes small.

A twelfth invention is a speech decoding apparatus wherein, in the tenth invention, the frame erasure concealment section has a first excitation decoding section that generates a first excitation decoded signal that is an excitation decoded signal of the second frame using encoded information of the second frame, a second excitation decoding section that generates a second excitation decoded signal that is an excitation decoded signal of the second frame using redundant information of the first frame, and a switching section that has the first excitation decoded signal and the second excitation decoded signal as input and outputs one or other signal in accordance with packet loss information of the second frame. For example, the first excitation decoded section can be represented by delay section 152, ACB decoding section 154, FCB decoding section 155, gain decoding section 156, adaptive codebook vector amplifier 157, fixed codebook vector amplifier 158, and adder 159 collectively, the second excitation decoding section can be represented by preceding frame excitation decoding section 160, and the switching section by switch 161.

It goes without saying that the correspondence between the configuration elements of the above inventions and the configuration elements in FIG. 7 and FIG. 8 is not necessarily limited to such correspondence.

It is possible for a speech encoding apparatus according to this embodiment to perform encoding with emphasis placed on parts important for the generation of an ACB vector of a current frame within excitation information of the current frame, such as a pitch peak section contained in the current frame, for example, and transmit generated encoded information to a speech decoding apparatus as encoded information for frame erasure concealment. Here, a pitch peak is a part with large amplitude that appears periodically at pitch period intervals in a speech signal linear predictive residual signal. This large-amplitude part is a pulse waveform that appears at the same period as a pitch pulse due to vocal cord vibration.

To be more precise, an encoding method that places emphasis on a pitch peak section of excitation information entails representing an excitation part used in a pitch peak waveform as an impulse (or simply a pulse), and encoding this pulse position as sub encoded information of the preceding frame for erasure concealment use. At this time, encoding of a position at which a pulse is located is performed using a pitch period (adaptive codebook) and pitch gain (ACB gain) obtained in the main layer of the current frame. Specifically, an adaptive codebook vector is generated from this pitch period and pitch gain, and a pulse position is searched for such that this adaptive codebook vector becomes effective as an adaptive codebook vector of the current frame—that is, error between a decoded signal based on this adaptive codebook vector and an input speech signal becomes minimal.

Thus, a speech decoding apparatus according to this embodiment can implement decoding of a pitch peak, which is the most characteristic part of an excitation signal, with a certain degree of precision by locating a pulse based on transmitted pulse position information and generating a synthesized signal. That is to say, even if a speech codec that utilizes an adaptive codebook or suchlike past excitation information is used as a main layer, an excitation signal pitch peak can be decoded without utilizing past excitation information, and pronounced degradation of a decoded signal of the current frame can be avoided even if the preceding frame is lost. This embodiment is particularly useful for a voiced onset section or the like for which past excitation information cannot be referred to. Also, simulation shows that the bit rate of redundant information can be kept down to approximately 10 bits/frame.

According to this embodiment, since redundant information is sent for one frame before, a concealment algorithm delay does not occur on the encoder side. This means that the algorithm delay of the entire codec can be made one frame shorter instead of provision being made for information for achieving high-quality erasure concealment processing not to be used at the discretion of the decoder side.

According to this embodiment, since redundant information is sent for one frame before, whether or not a frame for which loss is assumed is an onset frame or suchlike important frame can be determined using temporally future information as well, and the precision of determination as to whether or not a frame is an onset frame can be improved.

According to this embodiment, a more suitable item can be encoded as an ACB by taking an FCB component of the current frame into consideration when performing a search.

This concludes a description of an embodiment of the present invention.

A speech encoding apparatus, speech decoding apparatus, and frame erasure concealment method according to the present invention are not limited to the above-described embodiment, and various variations and modifications may be possible without departing from the scope of the present invention.

For example, a configuration may be used whereby ACB encoded information for concealment use is encoded in frame units rather than in subframe units.

Also, in this embodiment of the present invention, one pulse per frame has been assumed for pulses placed in frames, but it is also possible for a plurality of pulses to be placed to the extent that the amount of information transmitted permits.

A configuration may also be used whereby, in preceding frame excitation encoding of one frame before, error between a synthesized signal and input speech of one frame before is incorporated in evaluation criteria at the time of an excitation search.

A configuration may also be used in which a selection section is provided that selects either a decoded speech signal of the current frame decoded using ACB encoded information for concealment use (that is, an excitation pulse searched for by preceding frame excitation search section 110), or a decoded speech signal of the current frame decoded without using ACB encoded information for concealment use (that is, when concealment processing is performed by means of a conventional method), and ACB encoded information for concealment use is transmitted and received only when a decoded speech signal of the current frame decoded using ACB encoded information for concealment use is selected. Measures that can be used as a selection criterion by the above selection section include an SN ratio between the current frame input speech signal and decoded speech signal, or the evaluation measure used by preceding frame excitation search section 110, normalized using the energy of the target vector.

It is possible for a speech encoding apparatus and speech decoding apparatus according to the present invention to be installed in a communication terminal apparatus and base station apparatus in a mobile communication system, by which means a communication terminal apparatus, base station apparatus, and mobile communication system can be provided that have the same kind of operational effects as described above.

A case has here been described by way of example in which the present invention is configured as hardware, but it is also possible for the present invention to be implemented by software. For example, the same kind of functions as those of a speech encoding apparatus or speech decoding apparatus according to the present invention can be implemented by writing an algorithm of a frame erasure concealment method according to the present invention including both encoding/decoding in a programming language, storing this program in memory, and having it executed by an information processing means.

The function blocks used in the description of the above embodiment are typically implemented as LSIs, which are integrated circuits. These may be implemented individually as single chips, or a single chip may incorporate some or all of them.

Here, the term LSI has been used, but the terms IC, system LSI, super LSI, ultra LSI, and so forth may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosures of Japanese Patent Application No. 2006-192069, filed on Jul. 12, 2006, and Japanese Patent Application No. 2007-051487, filed on Mar. 1, 2007, including the specifications, drawings and abstracts, are incorporated herein by reference in their entirety.

### INDUSTRIAL APPLICABILITY

A speech encoding apparatus, speech decoding apparatus, and frame erasure concealment method according to the present invention can be applied to such uses as a communication terminal apparatus and base station apparatus in a mobile communication system.

1. A frame erasure concealment method that performs concealment by artificially generating in a speech decoding apparatus a speech signal that should be decoded from a packet lost on a transmission path between a speech encoding apparatus and said speech decoding apparatus, said frame erasure concealment method comprising:
a step of, in said speech encoding apparatus, encoding redundant information of a first frame that is a current frame that makes decoding error of said first frame small using encoded information of said first frame; and
a step of, in said speech decoding apparatus, when a packet of a second frame that is a frame immediately preceding said current frame is lost, generating a decoded signal of a packet of lost said second frame using redundant information of said first frame that makes decoding error of said first frame small.

2. The frame erasure concealment method according to claim 1, wherein decoding error of said first frame is error between a decoded signal of said first frame generated based on decoded information and redundant information of said first frame and an input speech signal of said first frame.

3. The frame erasure concealment method according to claim 1, wherein redundant information of said first frame is information that encodes an excitation signal of said second frame that makes decoding error of said first frame small in said speech encoding apparatus.

4. The frame erasure concealment method according to claim 1, wherein said encoding step places a first pulse on a time axis using encoded information and redundant information of said first frame of said input speech signal, places a second pulse indicating encoded information of said first frame at a time later by a pitch period than said first pulse on said time axis, finds said first pulse that makes error between an input speech signal of said first frame and a decoded signal of said first frame decoded using said second pulse small by searching within said second frame, and takes a position and amplitude of found said first pulse as redundant information of said first frame.

5. A speech encoding apparatus that generates and transmits a packet containing encoded information and redundant information, said speech encoding apparatus comprising a current frame redundant information generation section that generates redundant information of said first frame that makes decoding error of said first frame that is a current frame small using encoded information of said first frame.

6. The speech encoding apparatus according to claim 5, wherein decoding error of said first frame is error between a decoded signal of said first frame generated based on decoded information and redundant information of said first frame and an input speech signal of said first frame.

7. The speech encoding apparatus according to claim 5, wherein redundant information of said first frame is information that encodes an excitation signal of a second frame that is a frame immediately preceding said current frame that makes decoding error of said first frame small.

8. The speech encoding apparatus according to claim 5, wherein said current frame redundant information generation section comprises:
a first pulse generation section that places a first pulse on a time axis using encoded information and redundant information of said first frame of said input speech signal;
a second pulse generation section that places a second pulse indicating encoded information of said first frame at a time later by a pitch period than said first pulse on said time axis;
an error minimizing section that finds said first pulse such that error between an input speech signal of said first frame and a decoded signal of said first frame decoded using said second pulse becomes minimal by searching within a second frame that is a frame preceding said current frame; and
a redundant information encoding section that encodes a position and amplitude of found said first pulse as redundant information of said first frame.

9. The speech encoding apparatus according to claim 8, wherein said redundant information encoding section quantizes a position of said first pulse using one fewer bits than a necessary number of bits according to a possible value of a position of said first pulse, and encodes a post-quantization position.

10. A speech decoding apparatus that receives a packet containing encoded information and redundant information and generates a decoded speech signal, said speech decoding apparatus comprising a frame erasure concealment section that takes a current frame as a first frame and takes a frame immediately preceding said current frame as a second frame, and when a packet of said second frame is lost, generates decoded information of a packet of lost said second frame using redundant information of said first frame generated in such a way that decoding error of said first frame becomes small.

11. The speech decoding apparatus according to claim 10, wherein redundant information of said first frame is information generated so that, when a speech signal is encoded, error between a decoded signal of said first frame generated based on encoded information and redundant information of said first frame and a speech signal of said first frame becomes small.

12. The speech decoding apparatus according to claim 10, wherein said frame erasure concealment section comprises:
a first excitation decoding section that generates a first excitation decoded signal that is an excitation decoded signal of said second frame using encoded information of said second frame;
a second excitation decoding section that generates a second excitation decoded signal that is a excitation decoded signal of said second frame using redundant information of said first frame; and
a switching section that has said first excitation decoded signal and said second excitation decoded signal as input and outputs one or other signal in accordance with packet loss information of said second frame.
